(19) United States
(12) Patent Application Publication
(10) Pub. No.: US 2007/0206220 A1
(43) Pub. Date: Sep. 6, 2007

(54) Method and system for product registration

(76) Inventors: Brian C. Berg, Phoenix, AZ (US); Lisa Berg, Phoenix, AZ (US)

Correspondence Address: TIFFANY & BOSCO;CAMELBACK ESPLANADE II, THIRD FLOOR, 2525 EAST CAMELBACK ROAD, PHOENIX, AZ, 85016, US

(21) Appl. No.: 11/713,168

(22) Filed: Mar. 1, 2007

Related U.S. Application Data
(60) Provisional application No. 60/778,567, filed on Mar. 2, 2006.

(51) Int. Cl. G06F 3/12

(52) U.S. Cl. 358/1.15

(57) ABSTRACT

A computer-readable registration medium has a unique computer-readable identifier. The registration medium identifier is stored in a computer database. Also stored in the computer database are a box identifier associated with a box in which the registration medium is packed and product information for a product packed in the box. The registration medium identifier is associated with the box identifier, which is associated with the stored product information for the product. The registration medium can be a CD-ROM having the registration medium identifier encoded thereon and having a barcode disposed thereon. The registration medium causes a user computer to read the registration medium identifier, prompt the user to enter registration information into the user computer, and send the registration medium identifier and the entered registration information to a product registration computer.

### RELATED APPLICATION DATA

This application is based on and claims the benefit of U.S. Provisional Patent Application No. 60/778,567 filed on Mar. 1, 2006, the disclosure of which is incorporated herein in its entirety by this reference.

### COPYRIGHT NOTIFICATION

Portions of this patent application include materials that are subject to copyright protection. The copyright owner has no objection to the facsimile reproduction by anyone of the patent document itself, or of the patent application as it appears in the files of the United States Patent and Trademark Office, but otherwise reserves all copyright rights whatsoever in such included copyrighted materials.

### BACKGROUND

This invention relates generally to product registration. More particularly, it relates to an improved method and system for online product registration.

Most paper-based product registration response rates hover unsatisfactorily in single digit percentages. Unfortunately, attempts to use alternative methods for customers to register products have fallen short of expectations. Even online-based product registration sites, while having marginally higher response rates, still have not demonstrated a significant advantage over paper-based registrations.

Most customers do not take the time to register due to four factors, i.e. inconvenience, low perceived value, privacy concerns and the registration card being discarded or not received. Of those who do register, many have difficulty finding the product serial number or end up incorrectly typing or writing down the relevant product information. Even automated postal sorters can introduce loss during mail processing. This drives up the overall cost per response, especially as incremental costs for follow up communication are factored in.

There is a need, therefore, for an improved method and system for product registration. It is an object of the present invention to provide such a method and system.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY

To achieve the foregoing objects, and in accordance with the purposes of the invention as embodied and broadly described in this document, there is provided a system and method for facilitating online product registration. According to the method, a computer-readable registration medium is provided, which has a unique computer-readable identifier. The registration medium identifier is stored in a computer database. Also stored in the computer database are a box identifier associated with a box in which the registration medium is packed and product information for a product packed in the box. The registration medium identifier can then associated with the box identifier, which can be associated with the stored product information for the product packed in the box. The stored product information can be selected from the group of product serial number, model, date of manufacture and distribution channel.

In one advantageous embodiment, registration medium can be an optical disc, such as CD-ROM or DVD, having the registration medium identifier encoded thereon and having a barcode disposed thereon. The registration medium can be packed with the product associated with the box. The registration medium identifier, the box identifier and the product information can be captured as the product is assembled or packaged. The box identifier can be a barcode and can be captured using a scanner as the product is assembled or packaged. The registration medium can be delivered to a customer and associated customer data can be received from the customer with the registration medium identifier. The associated registration medium identifier, box identifier and customer data can then be used to register the product.

According to another aspect of the invention, a method for facilitating online registration of a product purchased by a customer includes providing with the product a computer-readable registration medium having a unique computer-readable identifier that has been associated with the product. Instructions are included on the computer-readable medium for directing a customer computer to: read the registration medium identifier; prompt the customer to input customer data into the customer computer as part of a registration process; and send the registration medium identifier and the customer data to a registration computer for storage in a database. In this way, the registration medium can be associated with the customer data. The stored registration medium identifier can be associated with product data for a product packaged with the registration medium. The customer data also can be associated with the product.

Access can be provided to content stored on the computer-readable medium after the product is registered. The registration medium identifier and the customer data can be used to provide incentives to the customer.

According to yet another aspect of the invention, a computer-readable medium includes computer-executable instructions for facilitating product registration over a network. The computer-executable instructions being operative to perform actions including: causing a user computer to read a registration medium identifier encoded in the computer readable storage medium; prompting the user to enter registration information into the user computer; and sending the registration medium identifier and the entered registration information to a product registration computer for registering a product associated with the registration medium.

The computer-executable instructions can also be operative to provide access to content stored on the computer-readable medium after the product is registered. The stored content can include, for example, a product manual, interactive training for the product, a link to a website, a promotional code or a code that is redeemable online for an incentive.

The method and system of the present invention provide an end-to-end customer communication solution. The invention offers manufacturers of consumer goods a more effective way to collect product registration data and other information from their customers as compared to traditional paper response cards. Such manufacturers can include, for example, manufacturers of consumer electronics, appliances, outdoor power equipment, automotive products, aerospace products, fitness equipment, computer peripherals, and the like.

### BRIEF DESCRIPTION OF THE DRAWINGS

The accompanying drawings, which are incorporated in and constitute a part of the specification, illustrate the presently preferred embodiments of the invention, and together with the general description given above and the detailed description of the preferred methods and embodiments given below, serve to explain the principles of the invention.

FIG. 1 is a diagram of a preferred computer network system for facilitating online registration according to the present invention.

FIG. 2 is a block diagram of one example of a process for uniquely identifying the computer-readable registration medium and storing the identification information in a registration computer system according to the invention.

FIG. 3 depicts a computer-readable registration medium with a bar code thereon, a product box with a box barcode and a scanner for automatically capturing the registration medium and box barcodes during product packaging according to the present invention.

FIG. 4 is a block diagram of an exemplary process by which the computer-readable registration medium is associated with a specific product to be delivered to a customer according to the present invention.

FIG. 5 is a block diagram of an exemplary process by which the product delivered to the customer is registered online with the registration computer system according to the present invention.

FIGS. 6A-6J show examples of customer computer screen displays for implementing the product registration process according to the present invention.

FIGS. 7A-7E show examples of customer computer screen displays for providing additional content, offers, promotions and incentives to a customer who has registered a product according to the present invention.

### DESCRIPTION

Reference will now be made in more detail to presently preferred methods and embodiments of the invention, as illustrated in the accompanying drawings. While the invention is described more fully with reference to these examples and drawings, the invention in its broader aspects is not limited to the specific details, representative devices, and illustrative examples shown and described. Rather, the description which follows is to be understood as a broad, teaching disclosure directed to persons of ordinary skill in the appropriate arts, and not as limiting upon our invention.

A preferred system and method according to the present invention utilizes a CD-ROM or other computer-readable registration medium delivered to the purchaser of a product. The computer readable medium is included in the box along with the product. A master database of information indicating which CD-ROM went into which product box is generated during the product assembly and/or packaging process. The CD-ROM facilitates the collection of customer data, which is sent over a network connection, such as a secure Internet connection, to a registration computer system that stores the information in the database. From there the data can be formatted as required and forwarded to the manufacturer's existing warranty management system.

The method and system of the present invention enables product manufacturers and sellers to engage and build a dialog with new customers during an influential window of opportunity in the purchase cycle: product registration. Because customers have a high tendency to transact immediately after registration, the invention can be used to deliver a welcome message that can contain highly personalized offers on merchandise, incentives to refer friends and family or simply to prompt them to visit the product manufacturer's website. Whether the manufacturer's goal is to begin a conversation, evoke a specific customer behavior, or encourage additional transactions, the method and system of the present invention offers the opportunity to maximize the value of this out-of-the-box customer touch-point.

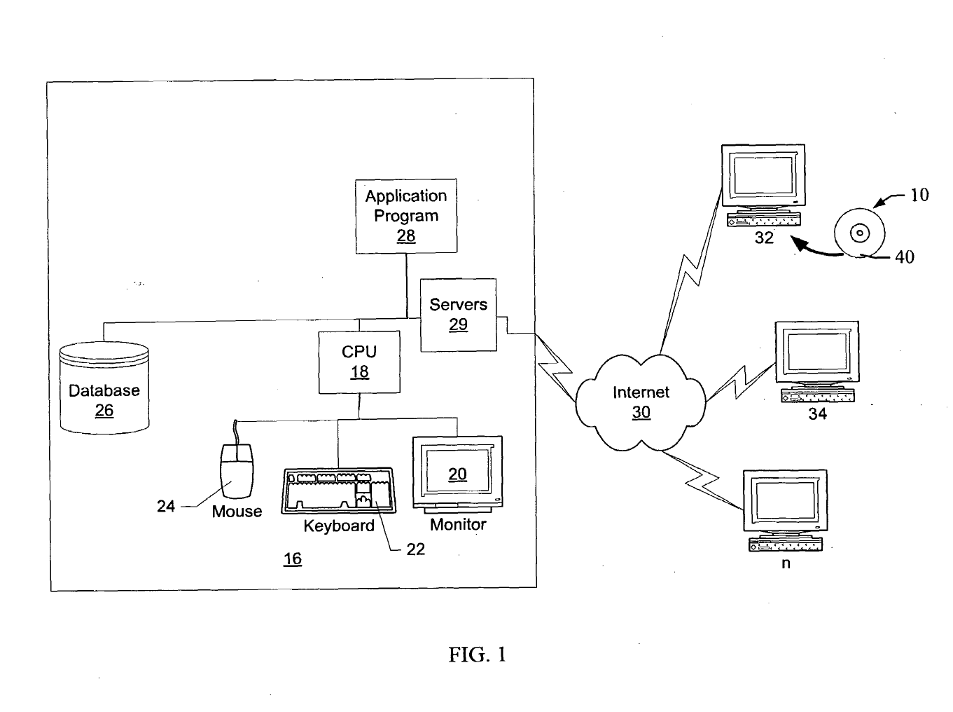

FIG. 1 illustrates a preferred computer network system for facilitating online registration according to the present invention. The system includes a registration computer system 16, which has a central processing unit (CPU) 18 for processing data and program instructions. The registration computer system 16 also includes input and output devices, as are well known in the art. For example, the registration computer system 16 preferably includes a display screen or monitor 20, a keyboard 22, a mouse 24, a printer (not shown), etc. The registration computer system 16 further includes data storage and memory devices, as are known in the art, for storing a database 26, an application program 28 and suitable servers 29. The database 26 comprises one or more databases for storing data used by the application program 28, including registration media identifiers and barcodes, box barcodes, product data and customer data, as described below. The database 26 is a relational database, as are well known in the art. The application program 28 is operable with the database 26 and the servers 29 to provide the functionality described below.

Still referring to FIG. 1, the registration computer system 16 is connected to a network 30, which serves as a communications medium with user computers 32, 34 and n (where n refers to any number of users). In a preferred embodiment of the invention, the network 30 comprises the Internet and the servers 29 include a web server to serve web pages to user computers 32, 34 and n, an email server for delivering emails to customers, a reporting server for generating reports and charts of registration activity and a warranty management server for importing data into analysis software or a claims processing system. Upon reading this specification, those skilled in the art will understand that, under appropriate circumstances, considering issues such as developments in computer hardware, software and connectivity, etc., other network configurations and devices also may suffice, such as for example, PDAs connected via a wireless network, etc.

Each of the user computers 32, 34, n can communicate with the network 30 and the registration computer system 16. In an exemplary embodiment, each of the user computers 32, 34, n is conventional personal computer having an input device, such as a keyboard, mouse, or conventional voice recognition software package; a display device, such as a video monitor; a processing device such as a CPU; and a network interface such as a conventional modem. Each of the user computers has a device for reading the computer-readable registration medium 10 discussed below.

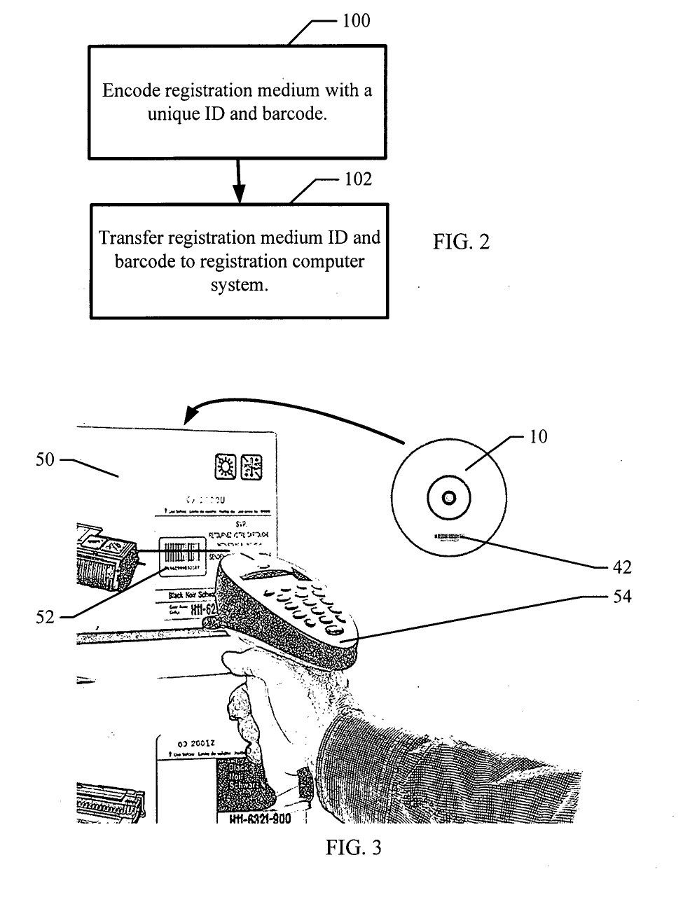

According to one aspect of the invention, a computer-readable registration medium 10, such as a compact disc (CD) or a digital video disc (DVD), is used to facilitate a customer's online registration of a product. FIG. 2 shows one example of a process for identifying the computer-readable medium 10 and storing the identification information in the database 26. Referring to FIG. 2, the registration medium 10 is encoded with a unique identifier (ID) 40 (see FIG. 1) and is labeled with a barcode 42 (step 100). The registration medium identifier 40 and barcode 42 are also transferred to the registration computer system 16 for storage in the database 26 (step 102).

In a presently preferred embodiment, the registration medium 10 is implemented using optical disc technology available from Sony DADC of Terre Haute, Ind. This optical disc technology allows a unique identifying digital string of alphanumeric characters to be encoded onto the data surface of a CD-ROM. The registration medium barcode 42 also can be printed on the face of the disc. In this embodiment, the registration medium 10 is compatible with any standard CD-ROM drive without requiring the installation of additional software, drivers, or plug-ins. Thus, the consumer is not required to install specific software on the consumer computer 32, 34, n before registration can take place. Furthermore, the consumer need not keep any such software installed in order to continue receiving future messages from the manufacturer.

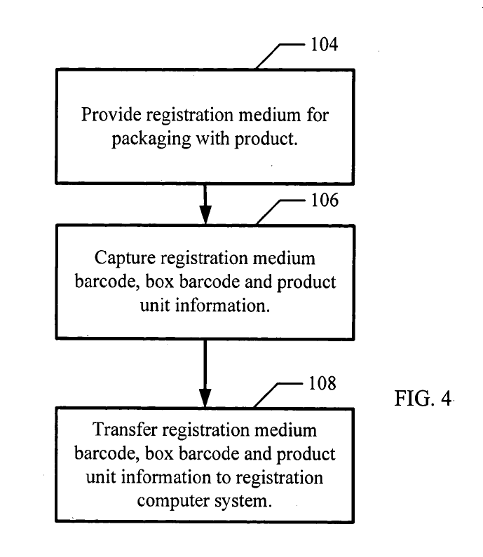

FIG. 4 shows an example of a process by which the computer-readable registration medium 10 is associated with a specific product unit to be delivered to a customer. Referring to FIG. 4, the computer-readable registration medium 10 is provided to a product assembly or packaging facility to be packaged with a product unit (step 104). At the product assembly or packaging facility, the registration medium 10 is packed with the product unit into a product box 50, which has a box barcode 52. As the product is assembled and/or packaged for distribution, the registration medium barcode 42 and the box barcode 52 are captured, such as by using a barcode scanner 54 (step 106). Such scanner systems for capturing and storing barcode data are well known. Also during the product assembly and packaging process, product information about the product unit is captured. The product information can include, for example, the product's serial number, model, date of manufacture, distribution channel, and other pertinent information. The captured registration medium barcode 42, box barcode 52 and captured product information are then transferred to the registration computer system 16 for storage in the database 26 (step 108). The stored registration medium barcode 42 and box barcode 52 can then be used to associate a specific computer-readable registration medium 10 with the specific product unit with which it was packaged and with the specific product information for that product unit.

For capturing product serial number and registration medium identifier 40 at the point where the registration medium 10 is inserted into the product box, an industrialized data collection system can be used. If a manufacturer's lines already support barcode scanning, data collection can be integrated into the manufacturer's existing assembly process. Using suitable scanning hardware and software on the product assembly line, this unique code becomes the tracking number that links back to the product's serial number, date of manufacture, distribution channel, and other pertinent information. In addition, this tracking capability speeds up the registration process and eliminates any data entry errors by not requiring the customer to hunt down and type in their model and serial number during the registration process described below. FIG. 3 depicts one example of a computer-readable registration medium 10 with a bar code 42, a product box 50 with a box barcode 52 and a scanner 54 for automatically capturing the registration medium and box barcodes during product packaging according to the present invention.

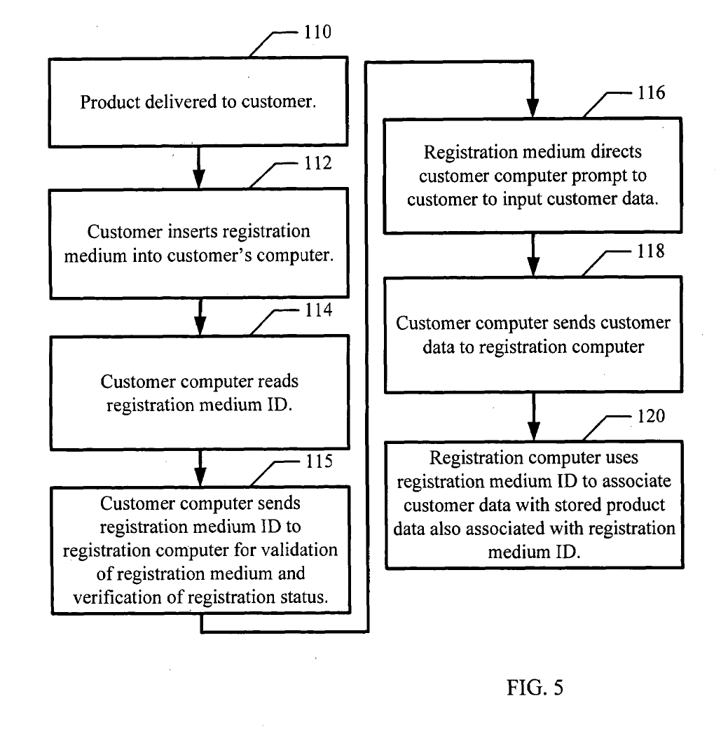

FIG. 5 shows an example of a process by which the computer-readable medium 10 is associated with a particular customer who receives the specific product associated with the computer readable medium 10. When the product unit is delivered to a customer (step 110), the customer removes the computer-readable registration medium 10 from the box in which it is packed with the product and inserts the registration medium 10 into his or her computer 32 (step 112). Under direction of programming stored on the registration medium 10, the computer 32 reads the registration medium identifier 40 (step 114). The registration medium 10 then causes the computer 32 to send the registration medium identifier 40 to the registration computer system 16 to validate the registration medium 10 and to verify the registration status of the product associated with the registration medium identifier 40 (step 115). The registration medium 10 then causes the computer 32 to guide the customer through a registration process by which the customer inputs customer data (step 116). The computer 32 then sends the customer data to the registration computer system 16 for storage in the database 26 (step 118). Once the registration medium identifier 40 and customer data are received by the registration computer system 16, the unique registration medium identifier 40 can be traced back to the exact product box 50 into which the registration medium 10 was placed. The customer data can then be matched to the manufacturer-supplied product data to build a one-to-one association between the customer and the product data (step 120).

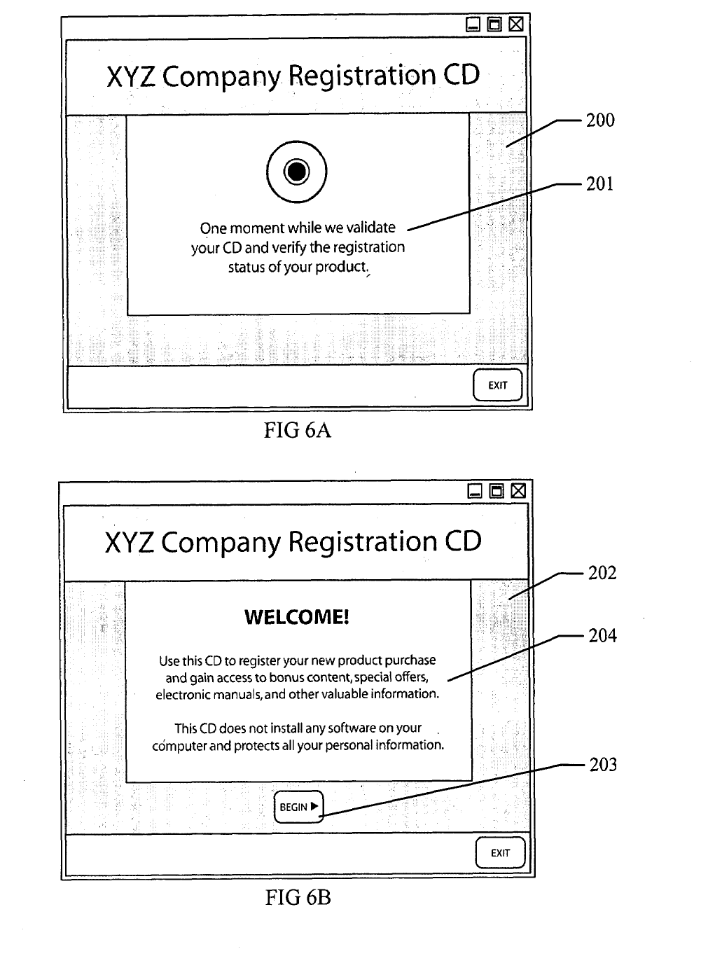

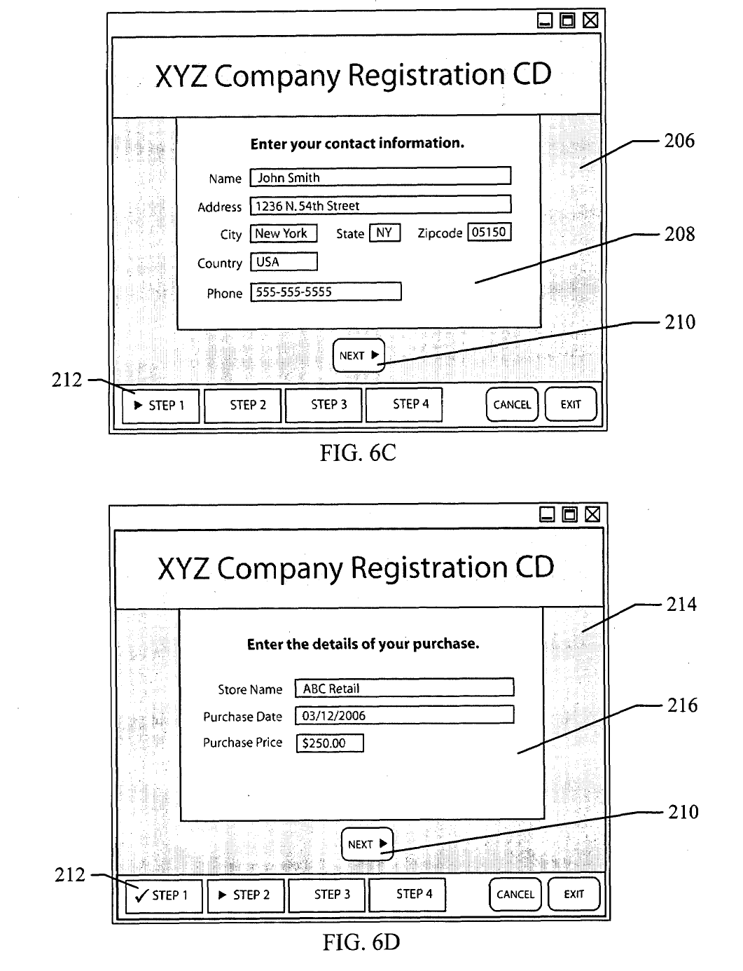

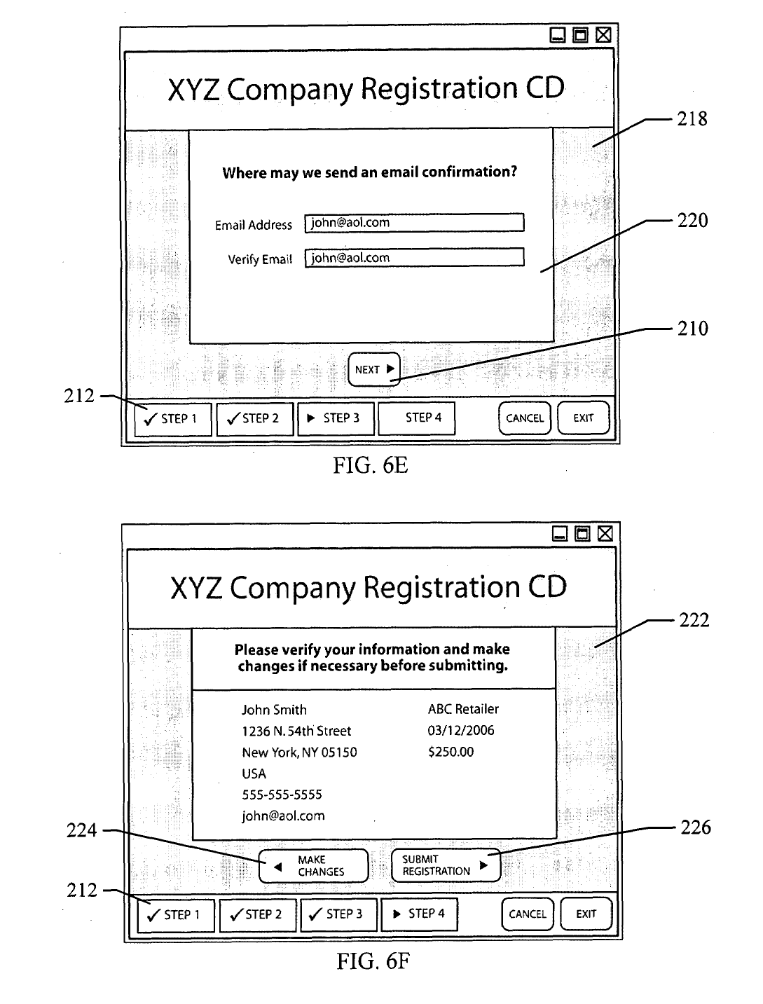

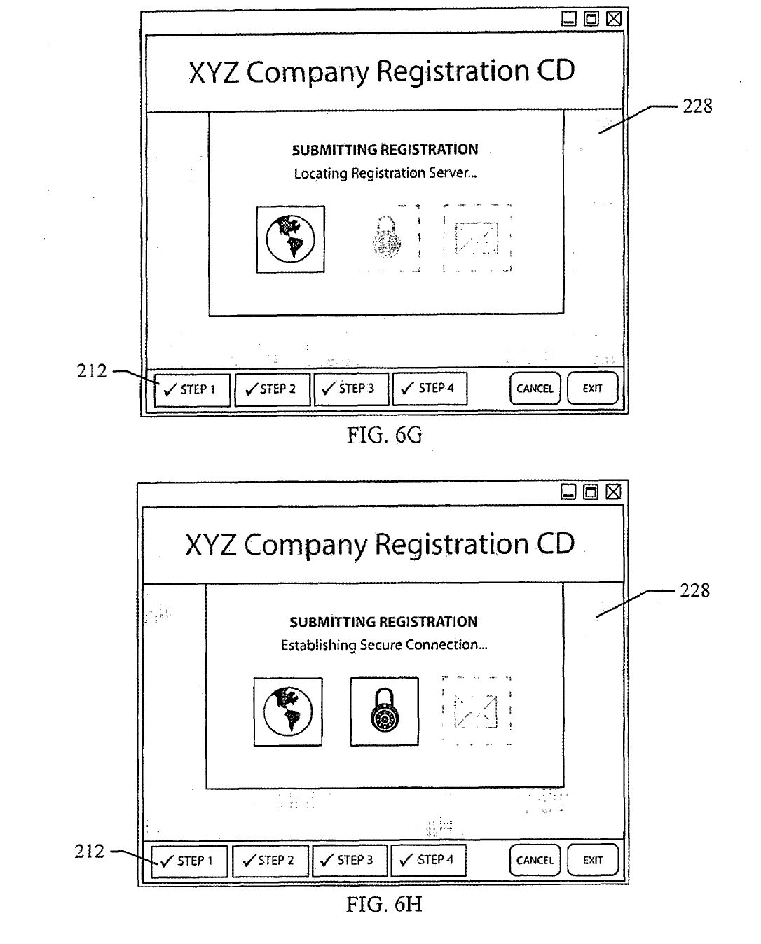

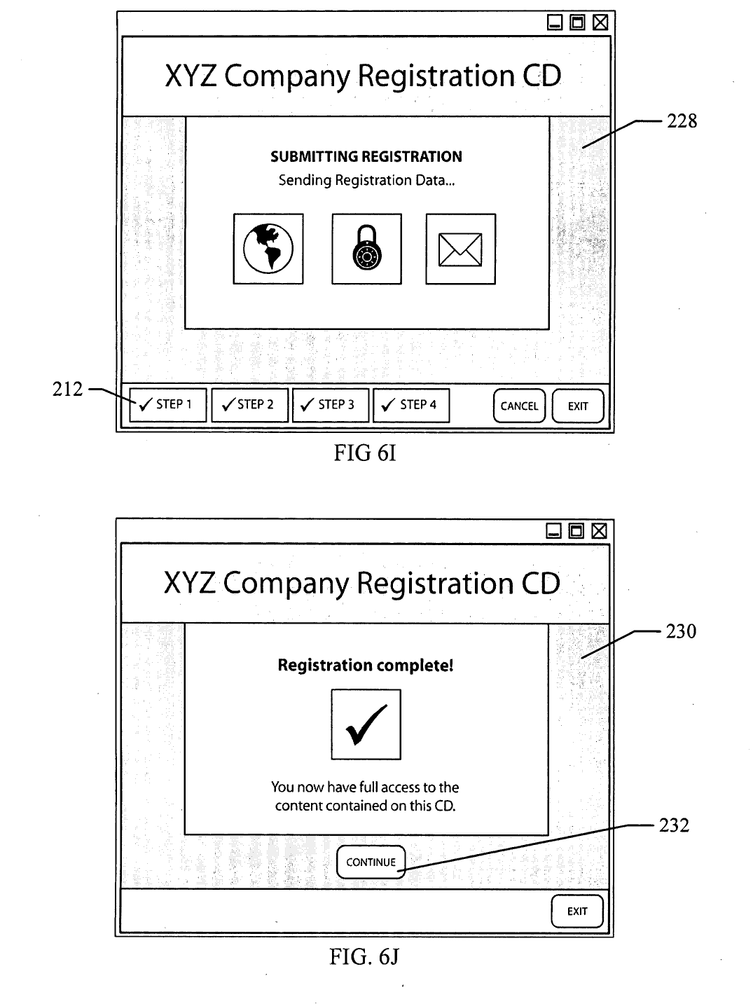

Referring to FIGS. 6A-6J, one example of the process by which the registration medium 10 directs the customer computer 32 to interact with the customer is described in more detail. As described above, when the registration medium 10 is inserted into the customer's computer 32, the computer 32 reads the registration medium identifier 40 (step 114) and validates the registration medium 10 and verifies the product registration status (step 115). During this process, the registration medium 10 directs the customer computer 32 to display an initial product registration screen 200 to the customer, such as that shown in FIG. 6A. This screen can include a message to the customer 201 indicating the status of the validation and registration verification process.

After the registration computer 16 validates the registration medium 10 and verifies the registration status of the associated product, it responds accordingly to the computer 32 and the registration medium 10 causes the computer 32 to display a welcome screen 202 to the customer, such as that shown in FIG. 6B. The screen includes a “Begin” button 203 for the customer to begin the registration process and also can include various messages to the customer 204, such as instructions and information on the benefits of registration and use of the registration medium 10.

When the customer begins the registration process, the registration medium 10 causes the computer 32 to display a series of screens for prompting the customer to input customer information specific to the customer and the purchase of the subject product, such as those screens in FIGS. 6C-6F. The example depicted in FIGS. 6C-6F involves four steps. In the first step, the registration medium 10 causes the computer 32 to display a contact information screen 206, which includes a section 208 for the customer to enter the customer's contact information (see FIG. 6C). The screen includes a “Next” button 210 for the customer to save the information entered and move to the next step in the process. The screen also can include a status bar 212, which shows the customer's progress in entering the customer information. In the second step, the registration medium 10 causes the computer 32 to display a purchase information screen 214, which includes a section 216 for the customer to enter the information regarding the details of the customer's purchase of the product (see FIG. 6D). In the third step, the registration medium 10 causes the computer 32 to display an email confirmation screen 218, which includes a section 220 for the customer to enter an email address where a confirmation of registration will be sent (see FIG. 6E). In the fourth step, the registration medium 10 causes the computer 32 to display a customer input verification screen 218, which allows a customer to review the information the customer has entered (see FIG. 6F). A “Make Changes” button 224 allows the customer to change information before submitting it, and a “Submit Registration” button 226 allows the customer to submit the information that the customer has entered.

When the customer selects the “Submit Registration” button 226, the registration medium 10 causes the computer 32 to submit the customer data to the registration computer system 16 (step 118). This submission process includes accessing the network 30, locating the registration computer system 16, establishing a connection with the registration computer system 16 and sending the registration data entered by the customer. During this process, the computer 32 displays a series of screens to that customer indicating the status of the submission process, such as those screens in FIGS. 6G-6J. When the registration process is complete, the registration computer system 16 so notifies the customer's computer 32, which displays a screen 230 advising the customer that registration is completed and that the customer can access additional content on the registration medium 10 by selecting a “Continue” button 232 on this screen, as shown in FIG. 6J.

In addition to facilitating product registration, the registration medium 10 can contain supplemental bonus content for the consumer to access. This can include, among other content, electronic PDF product manuals, interactive training lessons, live links to exclusive websites, special promotional codes for discounts on future purchases, or codes that are redeemable online for instant delivery of incentives.

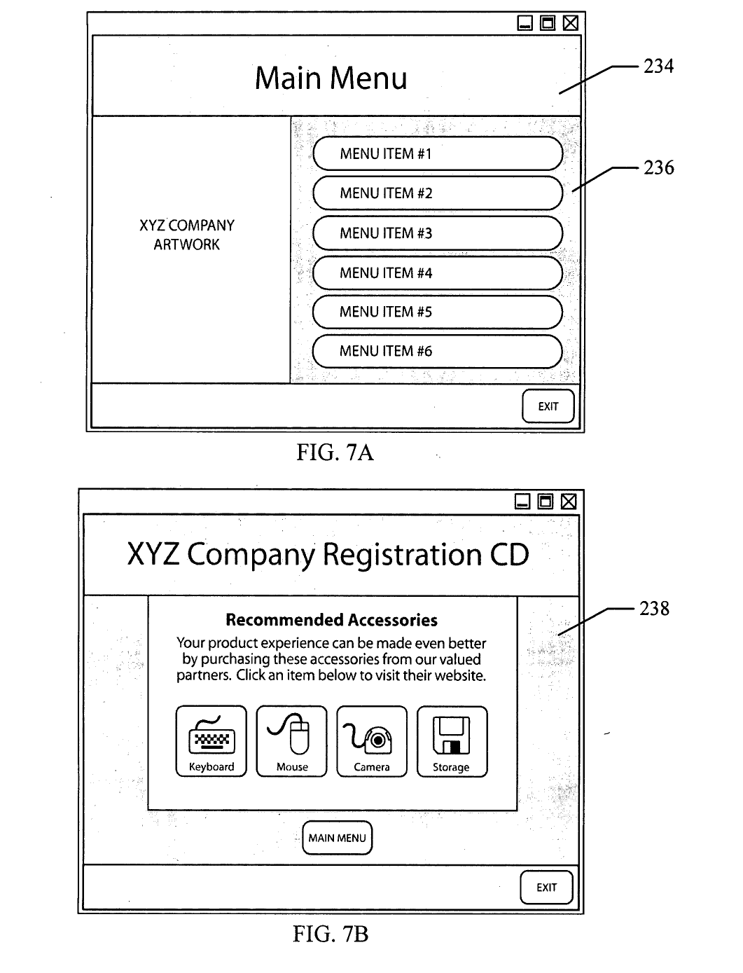

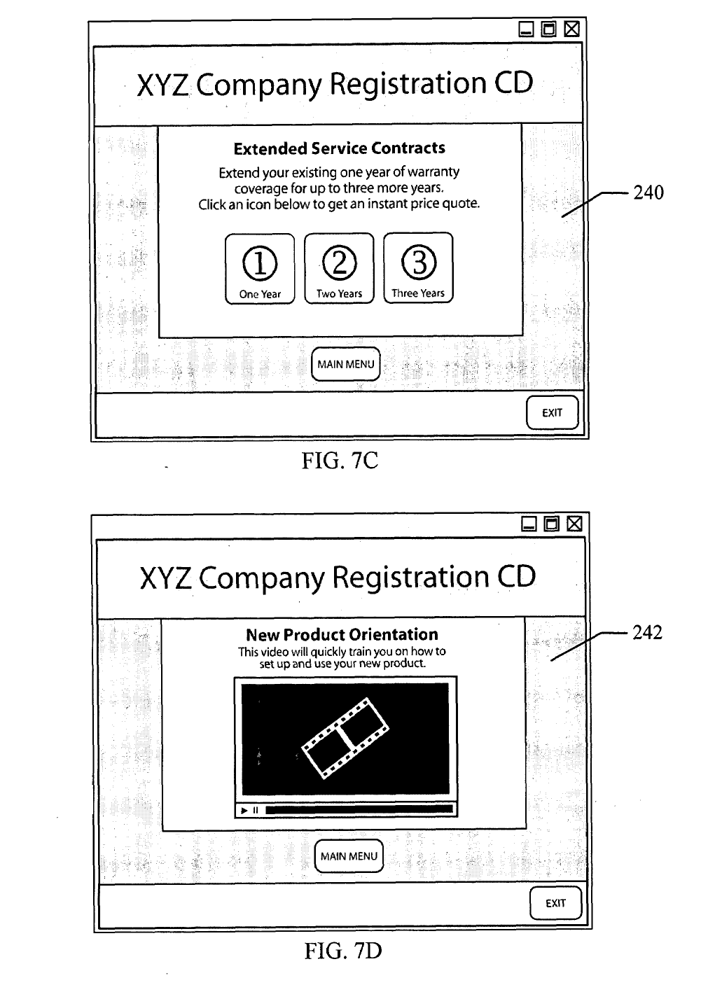

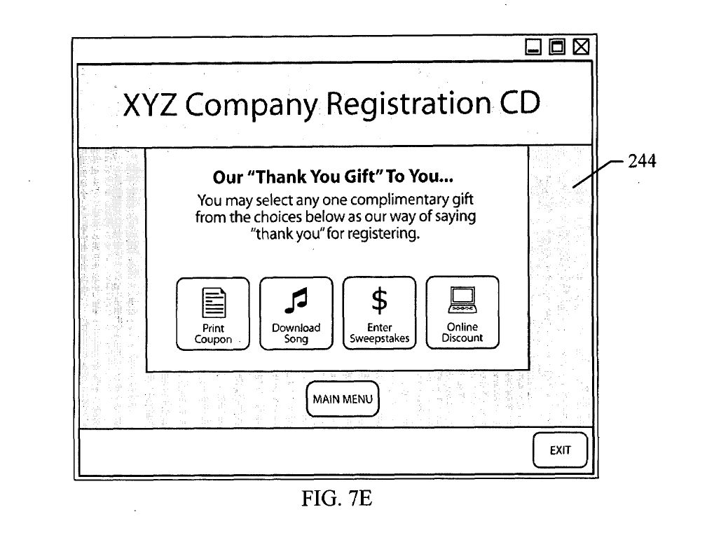

Referring to FIG. 6J, when the customer selects the “Continue” button 232, the registration medium 10 causes the computer 32 to display a main menu screen 234, such as that shown in FIG. 7A. The main menu screen 234 includes menu choices 236 for selecting various features included as content on the registration medium 10 or accessible as exclusive website content. These menu choices 236 can include, for example, product manuals, interactive training lessons or links to other content on exclusive websites. In addition, the menu choices 236 can include additional product or service offerings, special promotional codes for discounts on future purchases, or codes that are redeemable online for instant delivery of incentives.

For example, FIG. 7B shows a cross-marketing display screen 238 which provides links to websites of other product providers where a customer can purchase accessories for the product that the customer has registered. As another example, FIG. 7C shows a service contract display screen 240 by which a customer can purchase a contract extending the warranty on the product that the customer has registered. As still another example, FIG. 7D shows a new product orientation screen 242 by which a customer can access a training video on how to set up and use the product that the customer has registered. As yet another example, FIG. 7E shows an incentives display screen 244 by which a customer can select a complementary gift after the customer has registered a product.

In connection with delivering incentives to customers, the registration medium identifier 40 can be used as consumer's personal lottery number. The registration computer system 16 can automatically deliver incentives randomly, from a pre-selected list, or enter names into a group sweepstakes. Printable coupons can be offered, which when redeemed can be tracked back to the original purchaser.

The method and system of the present invention can include a number of other useful features to provide additional benefits. Bonus content can be used to promote the manufacturer's brand identity and enhance the consumer's out-of-the-box experience. Full service multimedia content can offer many options from which to choose.

An email campaign can be developed and executed. The method and system of the invention can be used to generate an automatic email when a customer registers their product, thanking them for their purchase. With email campaign services, periodic email newsletters can use data-driven rules to include personalized content and special offers.

Interactive adaptive surveys can be implemented. Intelligent surveys can react with different purpose-driven questions as each response is received, resulting in shorter surveys and more useful data.

Data security can be provided. Because there is no software to install on the customer's computer and all data is encrypted prior to transmission over the Internet, any negative consumer concerns over spyware, adware and identity theft can be alleviated. In addition, the data servers can sit behind multiple levels of firewall security to block unauthorized access, and the software can communicate with all proxy servers.

Secure reporting and data exchange can be made available. A secure website with password protected access can provide up-to-the-minute statistics and reports based on the data stored in the database. Data can be downloaded and imported into any statistical reporting system.

Warranty management can be provided, and data can be imported into analysis software or a claims management processing system.

From the foregoing disclosure, it will be seen that the present invention has numerous advantages. It can be used to provide true one-to-one correlation between a registration medium and a specific product by using a registration medium with a unique digital identifier encoded onto it. When a customer registers the product, this identifier automatically links the consumer to their purchased product, including model, serial number, manufacturing details and other pertinent information. This offers an easier registration experience for the consumer and allows the manufacturer to analyze customer behavior more effectively, while at the same time enhancing the manufacturer's overall warranty chain management.

The invention also can provide higher response rates and a lower cost per response. By offering greater customer convenience, attractive incentives and exceptional value, registration rates will increase, resulting in an overall drop in cost per response. The invention can provide revenue-generating opportunities for the manufacturer.

In addition, the invention can be used to drive consumer interest in purchasing extended warranty service contracts and useful accessories as well as to educate customers about complimentary products and to provide joint-marketing with other brand partners who can benefit from reaching the manufacturer's target demographic.

The invention also can provide increased accuracy of data collection. Built-in error checking of data, prior to submission, enhances the accuracy of the user's entire warranty management system. The unique identifier number eliminates the need for consumers to hunt for their serial number and possibly enter incorrect information or give up altogether.

Having read this disclosure, it will also be understood by those having skill in the art that the modifications may be made to the invention. Therefore, the invention in its broader aspects is not limited to the specific details, representative devices, and illustrative examples shown and described. Accordingly, departures may be made from such details without departing from the spirit or scope of the general inventive concept.

What is claimed is:

1. A method for product registration, the method comprising:
providing a computer-readable registration medium having a unique computer-readable identifier;
storing in a computer database;
the registration medium identifier;
a box identifier associated with a box in which the registration medium is packed; and
product information for a product associated with the box; and
associating the registration medium identifier with the box identifier;
whereby the registration medium identifier can be associated with the product information for the product associated with the box.

2. The method of claim 1 wherein the product information is selected from the group of product serial number, model, date of manufacture and distribution channel.

3. The method of claim 1 further comprising packing the computer-readable registration medium with the product associated with the box.

4. The method of claim 1 further comprising capturing the registration medium identifier, the box identifier and the product information as the product is assembled or packaged.

5. The method of claim 4 wherein the box identifier is captured using a scanner as the product is assembled or packaged.

6. The method of claim 1 further comprising delivering the registration medium to a customer and associating customer data received from a customer with the registration medium identifier.

7. The method of claim 6 further comprising using the associated registration medium identifier, box identifier and customer data to register the product.

8. The method of claim 1 wherein the registration medium comprises an optical disc having the registration medium identifier encoded thereon and having a barcode disposed thereon.

9. A method for facilitating online registration of a product purchased by a customer, the method comprising:
providing with the product a computer-readable registration medium having a unique computer-readable identifier associated with the product; and
including instructions on the computer-readable medium for directing a customer computer to:
read the registration medium identifier;
prompt the customer to input customer data into the customer computer as part of a registration process; and
send the registration medium identifier and the customer data to a registration computer for storage in a database;
whereby the registration medium can be associated with the customer data.

10. The method of claim 9 further comprising associating the stored registration medium identifier with product data for a product packaged with the registration medium.

11. The method of claim 10 further comprising associating the customer data with the product.

12. The method of claim 9 further comprising providing access to content stored on the computer-readable medium after the product is registered.

13. The method of claim 9 further comprising using the registration medium identifier and the customer data to provide incentives to the customer.

14. A computer-readable medium having computer-executable instructions for facilitating product registration over a network, the computer-executable instructions being operative to perform actions comprising:
causing a user computer to read a registration medium identifier encoded in the computer readable storage medium;
prompting the user to enter registration information into the user computer; and
sending the registration medium identifier and the entered registration information to a product registration computer for registering a product associated with the registration medium.

15. The computer readable storage medium of claim 14 wherein the computer-executable instructions are further operative to provide access to content stored on the computer-readable medium after the product is registered.

16. The computer readable storage medium of claim 15 wherein the stored content comprises a product manual.

17. The computer readable storage medium of claim 15 wherein the stored content comprises interactive training for the product.

18. The computer readable storage medium of claim 15 wherein the stored content comprises a link to a website.

19. The computer readable storage medium of claim 15 the stored content comprises a promotional code.

20. The computer readable storage medium of claim 15 wherein the stored content comprises a code that is redeemable online for an incentive.
